(19) United States
(12) Patent Application Publication
(10) Pub. No.: US 2007/0164185 A1
(43) Pub. Date: Jul. 19, 2007

(54) Folding legs for removable seats of various vehicles

(76) Inventor: Robert Burge, Hattiesburg, MS (US)

Correspondence Address: Mr. Timothy D. Smith, 5075 Canton Heights Drive, Jackson, MS, 39211, US

(21) Appl. No.: 11/333,596

(22) Filed: Jan. 17, 2006

(51) Int. Cl. F16M 13/00

(52) U.S. Cl. 248/421

(57) ABSTRACT

This invention is an apparatus that can be attached to the bottom of removable vehicle seats that contains folding legs that can be extended when the seat is removed from the vehicle to facilitate legs for the seat which can be placed on the ground, providing for clearance above the ground, just as the normal legs of a chair or seat as well as prevent the seat from directly contacting the ground which could result in damage to the seat by various means. These folding legs can be folded up when not in use and take up on nominal amounts of space when the seat is returned to its host vehicle in its typical position within that vehicle. The invention is useful in that it allows persons who travel on trial rides or who tailgate or have any use for seats outside of the vehicle who don't want to compromise space by providing a functional seat with legs outside of the vehicle. The main components of this invention consists of a main frame that is to be secured to the underside of the seat. This main frame has attached to it two U-shaped legs with requisite support arms to hold them in place. It also contains two rear struts to aid in stability of the seat when the legs are extended and the seat is in use out side of the vehicle. The invention can be constructed out of metal, steel, aluminum or other appropriate tubing, including angle tubing.

### BACKGROUND OF THE INVENTION

(1) Technical Field of Invention

The general purpose of this invention is to provide folding legs to be attached to the bottom of the rear seat of various types of vehicles in which the rear seat can be removed. More specifically, this invention can be bolted to the bottom of these factory installed seats, and once the seat is removed from the vehicle, the folding legs can be extended resulting in support structures allowing the seat to function as a normal chair outside of the host vehicle. When the seat is in its place within the vehicle, the invention folds away under the seat taking up nominal amounts of space.

(2) Description of Prior Art

Virtually all CJ, YJ, and TJ model Jeeps have removable rear seats. These vehicles have been in production for decades and have been sold all over the world during this extended time period. The very nature of these vehicles facilitates numerous outdoor activities due to the off-road capabilities that they possess. Many owners and users of these vehicles use them for “trail rides” in which the vehicles are driven off-road for varying distances. Many times, the people participating in these trail rides will stop to relax and enjoy the countryside, camp, or simply take a break. The removable seat often has to serve a dual purpose as it can be removed and placed on the ground to serve as an exterior seat.

Unfortunately, these seats are not equipped with any type of legs or supports to prevent the bottom of the seat from resting flush with the ground. This results in an uncomfortable seating arrangement, it allows the seat to become dirty from direct contact with the ground and can damage the seat. To date, there has been no way to remedy this problem.

### BRIEF SUMMARY OF THE INVENTION

The present invention is an apparatus that is secured to the bottom of the removable vehicle seat that is comprised of folding legs and the resulting support structures that can be extended after removal of the seat from the vehicle and act as legs or support structures when the seat is placed on the ground.

This invention aims to facilitate an easily stored, sturdy structure that allows the removable seats of various vehicles to be used as seats on the open ground. These folding legs will provide ground clearance for the user when extended, adding to comfort when used as a seat outside of the vehicle as well as preventing the seat from becoming soiled or otherwise being damaged from direct contact with soil, rock, or other debris.

The purpose of this invention is to provide legs for the rear seat in CJ, YJ and TJ model Jeeps, however it can also be applied and attached to any other vehicle that contains a removable seat, so that once the seat has been removed from the vehicle the legs can be extended and the seat can be used just as any other seating area outside of the host vehicle. The legs are attached in such a way that the normal function of the seat, while in the vehicle, is not diminished in any way. The apparatus as illustrated in the drawings is constructed of ¾ inch square steel tubing, although it can be manufactured and constructed out of aluminum, stainless steel, round or angle tubing.

The apparatus consists of a rectangular base frame that is attached via bolts, screws or other applicable securing devices to the bottom of the removable seat. The base frame is constructed in such as fashion so as to facilitate a congruent shape with the bottom of the automobile seat. In other words, the frame is approximately the same size and shape as the bottom of the seat. The legs are constructed of the same materials as the rectangular base frame and each leg consists of two upright pieces of material of equal length. These upright pieces are attached, via welding, to a cross member at their respective ends. This results in a U-shaped assembly which ultimately will serve as the apparatus's leg. The bottom of the U-shaped leg assembly will be in contact with the ground there is attached another rectangular member that will function to level the legs with the angle of the seat in such a manner that the seat rests horizontal with the ground.

Attached to the backside of the rear corner of the U-shaped leg is an “anti-leanback strut”. This strut is essentially a triangular shaped device that is welded together out of the same material as the rest of this invention and is bolted onto the rear bottom portion of the leg in such a manner to allow it to rotate backwards essentially extending the area in which the leg is in contact with the ground. The strut's purpose is to facilitate a stabilizing effect to the rear portion of the seat when used on the ground to prevent the seat from flipping over backwards when weight is applied to the seat, such as when a person sits down. This strut pivots on the bolt attached to the U-shaped leg and folds away when not in use.

The U-shaped leg and its attachments are bolted to the main rectangular frame with preferably 5/16×2 inch bolts. These bolts connect the U-shaped legs at the top points of the U to the corners of the rectangular frame. The bolts facilitate a pivot in which the legs can be folded towards the middle of the frame.

In the center of the rectangular frame is a cross member bar which is likewise fashioned from the same material as the rest of the apparatus. It is welded in place and runs across the rectangle as opposed to the length of the rectangle.

Attached to this center cross member on one end and to the bottom of the U-shaped legs on the other are pivoting stabilizer bars. The stabilizer bars are comprised of two bars on each side of the center cross member, and upper and an lower which lock together when the folding legs are extended. Each folding leg have these dual stabilizer bars attached and these stabilizers are then attached to the center cross member.

The end of the upper stabilizer bar is bolted to the center cross member via a 5/16×1 ¼ inch bolt. There are two upper stabilizer bars, one for the right side of the apparatus and one for the left. Attached to the upper stabilizer bar is the lower stabilizer, which is bolted in a fashion that allows them to fold or collapse when in the folded position. The reason there is an upper and lower stabilizer bar on each side is to allow the bars to bend or fold in the center while the invention is in its folded position. The lower stabilizer bar is attached to the center of the bottom of the U-shaped leg and is held in place with a 5/16×1-¼ inch bolt. This bolt as well as the bolt on the upper stabilizer allows the stabilizer bars to move or rotate forward for storage or folding.

The connection point of the stabilizer bars and the center pivot contains a 5/16 inch locking nut to hold the stabilizer bar in place and prevent a collapsing of the fold out legs while the legs are extended for use outside of the vehicle. This 5/16 inch locking nut is an approximation and is not limited to this size.

This invention is useful because it allows the rear seat of Jeeps and other like vehicles to serve another purpose outside of the vehicle with the same degree of comfort as exhibited when the seat is in place within the vehicle. When the invention is in its folded position and the seat is secured in its normal position, the invention takes up only minimal amounts of under-seat space, leaving room for under-seat storage. Unless an observer is looking under the rear seat while the seat is within the vehicle, the invention cannot be seen and therefore is hidden.

This invention will allow the owners of these types of vehicles to enjoy the vehicles even more. From camping, to trail riding, to tailgating at sporting events, this invention facilitates an external seat that is naturally part of the vehicle. It does not take up valuable space needed to pack other items and helps to eliminate the need to provide for other seating arrangements, like bringing extra external seating. If extra room for storage is needed in the rear of the vehicle, the seat can be removed and these folding legs can be extended to prevent the seat from resting flush with the ground and potentially be soiled or damaged from contact with the ground.

### BRIEF DESCRIPTION OF SEVERAL VIEWS OF THE DRAWINGS

FIG. 1. illustrates the invention, and its many facets, with the legs in the extended position as well as the anti-leanback strut extended.

FIG. 2. illustrates the invention in its folded position as it would appear from above. This is the position of the invention when not in use.

FIG. 3. illustrates the invention as it appears when viewed from front and side profiles with the legs extended.

FIG. 4. Illustrates the invention as seen from above with the legs in their extended position.

### DETAILED DESCRIPTION OF THE INVENTION

The present invention pertains an apparatus that is to be secured to the bottom of removable rear seats primarily of CJ, YJ and TJ model Jeeps, but is not limited to just these models of vehicles. The purpose of the invention is to provide folding legs so that the removable seat may be used as a seat or chair on the ground surface or any other applicable surface and thus preventing the need to rest the removable seat directly on the ground. This invention provides legs for the removable seat that can be folded away when not in use. All drawings are schematic, not necessarily to scale and illustrate only parts essential to the understanding of the invention, whereas other parts are omitted from the drawings to preserve clarity. Throughout all drawings identical or similar parts are designated by the same references.

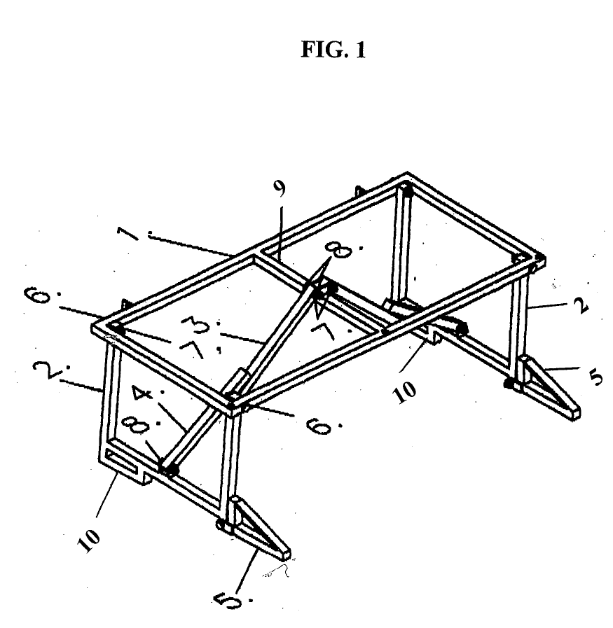

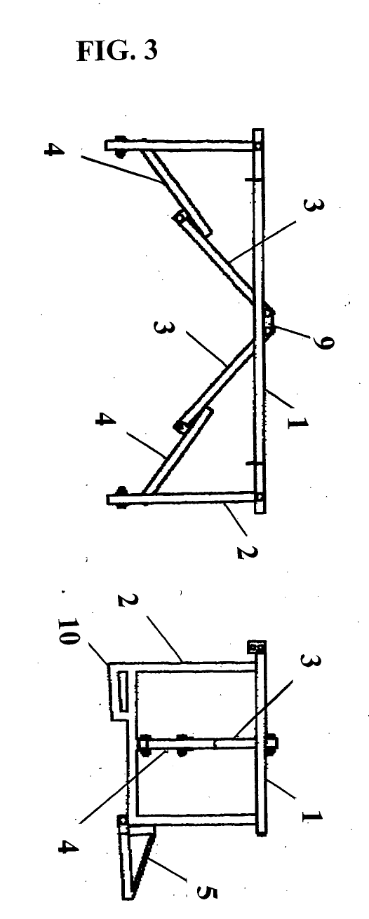

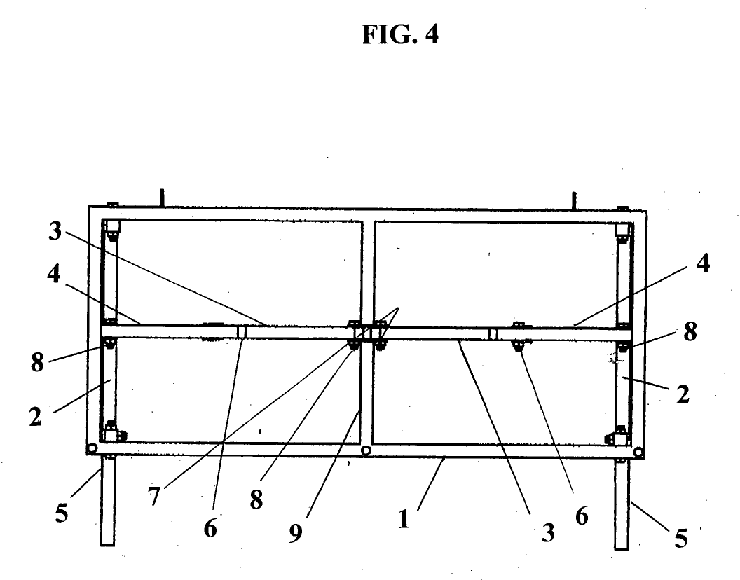

Referring to FIG. 1 through FIG. 4, the invention in comprised primarily of a rectangular main frame (1), two legs (2) and corresponding stabilizing bars (3) and (4). The invention as illustrated in the drawings is constructed of ¾ inch square steel tubing, although it can be manufactured and constructed out of aluminum, stainless steel, round or angle tubing, or any other applicable and appropriate material like plastic of any appropriate size. The rectangular frame (1) is comprised of welding the aforementioned applicable tubing together in the shape of a rectangle with two shorter pieces of tubing and two longer pieces of tubing. The dimensions of the tubing for the frame (2) will be customized or sized in accordance with the dimensions of the seat upon which it will be attached. The rest of the component parts of the invention will correspond dimensionally to the size of the frame (1) such that the invention will remain virtually to scale.

Referring to FIG. 1, the invention is seen with its legs (2) in the extended position as they would be used when the invention in removed from the vehicle and placed on an applicable surface. The rectangular frame (1) is to be secured by bolt, screw or other applicable means to the bottom of the removable seat, which is not seen in the illustrations. This holds the invention in place while in storage under the seat or while in use with the legs (2) extended.

The legs (2) are preferably to be manufactured out of the same material as the frame (1) and are fastened to the frame (1) by 5/16×2 inch bolts (6), or the like, in such a fashion to allow the legs (2) to rotate inward towards the center of the frame (1) for storage under the seat. The legs (2) are three pieces of appropriate tubing welded together at their ends to form a U-shape. The bottom of this U-shape functions as the bottom of the legs (2) that will be in contact with the ground or other applicable surface. The bolts (6) attach the frame (1) to the legs (2) at what amounts to the top two portions o the U shape. The bottom front portion of the respective legs has welded onto it a leg-support level (10) in order to facilitate a level seating surface when the seat is removed from the vehicle, the legs (2) are extended and the seat is placed on the ground or other applicable surface. The leg support-level (10) is to be preferably constructed out of the same material as the rest of the invention and consists of two short, upright pieces of tubing welded to a longer piece of tubing that will be in contact with the ground when the invention is in use. This structure (10) is welded into place on the bottom of the legs (2) on the portion of the legs (2) that will be under the front of the attached seat. On the back portion of the legs (2) are what are termed “anti-leanback struts” (5). These struts (5) are prefereably constructed of the same material as the rest of the invention and are comprised of three pieces of metal welded into the shape of a triangle. Also welded onto this strut (5) are attachment pieces that facilitate bolting of the struts (5) to the legs (2). These struts (5) are bolted to the back corners of the legs (2) in such a fashion that will allow them to rotate forward for storage when the legs (2) are folded up. The struts (5) are to be extended backwards when the legs (2) are folded out or down. The purpose of the struts (5) is to act as a brace to prevent the seat from rotating or flipping backwards when pressure is applied to the seat when in use outside of the vehicle.

Referring to FIG. 1 through 4, the rectangular frame (1) contains a center cross-member (9) that is welded into place in the center of the frame (1). The cross-member (9) is parallel to the two shorter portions of the rectangular frame (1) and is preferably comprised of the same tubing as the rest of the invention. This cross-member (9) provides further support to the frame (1) as well as connection point for the upper stabilizer bars (3) utilizing connection plates through which bolts can be placed. The upper stabilizer bars (3) are connected to the cross-member (9) with 5/16×1-¼ inch bolts (8) or the like through small brackets or connection plates welded onto the cross-member (9) which facilitate a pivoting action for the bars (3) when folding and unfolding the legs (2). The upper stabilizer bars (3) are locked into place when the legs (2) are extended by a 5/16 locking nut (7) or the like. This locking nut (7) is manipulated by the user to secure the stabilizers (3) and legs (2) of the invention when extended and when in storage.

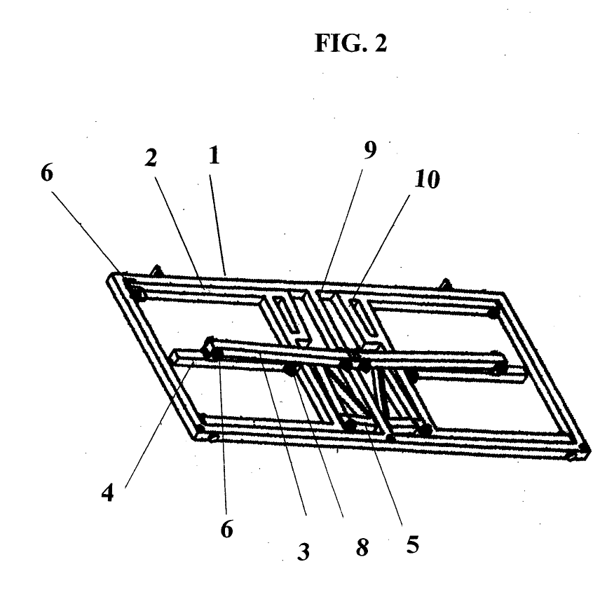

The upper stabilizer bars (3) are bolted to the lower stabilizer arms (4) in such a fashion as to allow them to pivot inward for folding and outward for unfolding. They are bolted together using 5/16×2 inch bolts (6) or the like. These bars (3) and (4) lock in place when downward and outward pressure is applied because their respective ends overlap while being bolted together. The purpose of the upper (3) and lower stabilizers is to facilitate a stabilizing effect on the legs (2) when folded down as seen in FIG. 1, and to aid in folding the legs (2) up when in the storage position as seen in FIG. 2.

The lower stabilizer bar (4) is attached to the center of the bottom runner of the legs (2) by a small bracket or connection plate that is welded into place with a 5/16×1-¼ inch bolt (8) or the like running through the bracket and the lower stabilizer arm (4). Like the upper stabilizer bar's (3) attachment to the center cross-member (9), the lower stabilizer (4) and its attachment with the bolt (8) allows the arm to pivot inward for folding and outward to a locking position when the legs (2) are down.

These components together form the invention which is bolted or fastened to the bottom of the appropriate seat. If ¾ inch tubing is used in the assembly of the invention, when in the folded position, as it would be under the seat while the seat is within the vehicle, the total of space taken up below the seat will roughly only be 1 ½ inches. Therefore, the invention does not take up valuable storage space under the seat while the seat is in position in the vehicle. The legs (2) can be of varying height when extended, depending on preference of the user/purchaser and could be designed to have a telescoping component to extend leg (2) length if desired.

Drawings

The drawings referenced in this application are attached hereto.

I claim:

1. An apparatus to be attached to the bottom of removable automobile seats comprising:
a rectangular shaped frame attached to the bottom of a automobile seat;
the rectangular shaped frame fitting congruently with the bottom of the automobile seat;
a cross member that dissects the rectangular frame and has attached at the center of this cross member two connector plates with holes to allow a bolt, pin or rivet to fit through;
two U-shaped legs attached to the ends of the rectangular frame that corresponded to the bottom side portion of the attached automobile seat by bolt, pin or rivet facilitating a pivoting motion;
two upper stabilizer bars, one for each side that connect to the cross member and to the lower stabilizer bars via bolt, pin or rivet;
two lower stabilizer bars, one for each side, that connect with the upper stabilizer bar by a bolt, pin or rivet and the bottom center portion of the U-shaped legs by bolt, pin or rivet;
rectangular shaped support levels attached to the front bottom portion of the U-shaped legs;
two triangular shaped struts pivotally attached by bolt, pin or rivet to the lower back respective corners of the U-shaped legs.

2. The apparatus as in claim 1, further comprising:
the support level attached to the front bottom portion of the U-shaped legs being used to level the apparatus and the attached seat when the U-shaped legs are extended and placed on the ground or other applicable surface.

3. The apparatus as in claim 1, further comprising:
the two triangular shaped struts pivotally attached to the lower back respective corners of the U-shaped legs being pivoted backwards from their respective storage positions to facilitate a stabilizing brace on the back portion of the U-shaped legs when extended and placed on the ground or other applicable surface.

4. The apparatus as in claim 1, further comprising:
the U-shaped legs having welded to their respective lower center portions connector plates with holes for connection to the lower stabilizer arms by bolt, pin or rivet.

5. The apparatus as in claim 1, further comprising:
bolts, pins or rivets used to connect various elements of the apparatus to facilitate pivoting and folding.

6. The apparatus as in claim 1, further comprising:
the various elements of the invention being manufactured from square metal, steel, aluminum or plastic tubing.

7. The apparatus as in claim 1, further comprising:
the various elements of the invention being manufactured from circular metal, steel, aluminum, or plastic tubing.

8. The apparatus as in claim 1, further comprising:
the various elements of the invention being manufactured from angular metal, steel, aluminum, or plastic.

9. The apparatus as in claim 1, further comprising:
locking nuts utilized to hold the stabilizer bars in a fixed position when folded or extended.

10. The apparatus as in claim 1, further comprising:
holes in the rectangular frame that facilitate bolting or affixing to the bottom of the automobile seat.

11. The apparatus as in claim 1, further comprising:
the U-shaped legs being manufactured with a telescoping aspect to facilitate extension of the length of the legs when unfolded from the storage or folded position.

12. The apparatus as in claim 1, further comprising:
attachment of the invention to the removable rear seat of CJ, YJ, and TJ Model Jeep® vehicles.

13. The apparatus as in claim 1, further comprising:
attachment of the invention to the removable seat of any appropriate vehicle.

14. A method of utilizing the apparatus, comprising the steps of:
attaching the apparatus to the bottom of a removable automobile seat by inserting bolts through the pre-drilled holes in the rectangular frame or by any other applicable method;
unlocking the stabilizer bars by manipulating the locking nut located at the connection point of the upper and lower stabilizer bars releasing the bars and U-shaped legs from their folded or storage position;
grasping the U-shaped legs of the invention and pulling them outward extending the upper and lower stabilizer arms;
locking the stabilizer bars in their extended position by manipulating the locking nut located at the connection point of the upper and lower stabilizer bars;
pivoting the struts out of their storage position away from the U-shaped legs to extend behind the U-shaped legs to provide rear support and stability to the invention and attached seat when in use on the ground or other applicable surface.

15. The method of claim 14, wherein:
the invention and attached seat is placed on the ground or any other appropriate surface.

16. The method of claim 14, wherein:
the invention is folded into its storage position by manipulating and securing the locking nuts, folding the U-shaped legs and upper and lower stabilizer arms inward and placing the invention and attached seat within the host vehicle.
